(19) United States
(12) Patent Application Publication
(10) Pub. No.: US 2014/0319901 A1
(43) Pub. Date: Oct. 30, 2014

(54) VEHICLE TIRE AND WHEEL ASSEMBLY WITH INSULATING MEMBER

(71) Applicant: GM GLOBAL TECHNOLOGY OPERATIONS LLC, Detroit, MI (US)

(72) Inventors: David J. Schmidt, Troy, MI (US); David L. Howland, Webberville, MI (US)

(73) Assignee: GM Global Technology Operations LLC, Detroit, MI (US)

(21) Appl. No.: 13/870,031

(22) Filed: Apr. 25, 2013

(51) Int. Cl. B60C 23/19

(52) U.S. Cl. CPC B60C 23/19
USPC 301/6.91; 152/153

(57) ABSTRACT

A tire and wheel assembly includes a wheel that has a rim. The wheel has a first thermal conductivity. A tire is attached to the wheel to define an annular tire cavity enclosed by the tire and the rim. An insulating member is on the rim within the tire cavity. The insulating member has a second thermal conductivity lower than the first thermal conductivity and is configured to absorb heat from the cavity when a temperature of the cavity is above a first predetermined temperature. The insulating member is also configured to release the absorbed heat back to the cavity when the temperature of the cavity is below a second predetermined temperature lower than the first predetermined temperature.

### TECHNICAL FIELD

The present teachings generally include a wheel assembly with a tire.

### BACKGROUND

Tires play an important role in vehicle fuel economy. The tire consumes energy as it rolls along the road surface, deflecting under the various forces generated between the road surface and the vehicle. The repeated cycles of deformation and recovery consume energy, referred to as hysteretic losses. The energy is ultimately provided by the fuel. Due to the hysteric losses within the structure of the tire, a certain amount of energy is consumed within the tire structure and then rejected into the surrounding environment as heat energy. Tires in general become more efficient, rejecting less energy to the environment, as the temperature of the tire increases. There are multiple heat energy rejection paths from the tire to the environment and some of those paths convey more energy than others.

### SUMMARY

A tire and wheel assembly includes a wheel that has a rim. The wheel has a first thermal conductivity. A tire is attached to the wheel to define an annular tire cavity enclosed by the tire and the rim. An insulating member is on the rim within the tire cavity. The insulating member has a second thermal conductivity lower than the first thermal conductivity and is configured to absorb heat from the cavity when a temperature of the cavity is above a first predetermined temperature. The insulating member is also configured to release the absorbed heat back to the cavity when the temperature of the cavity is below a second predetermined temperature lower than the first predetermined temperature. The insulating member can be a fibrous blanket. In another embodiment, the insulating member is a bladder filled with a liquid or gel. The tire and wheel assembly assists in retaining the warmth of the warm air generated during driving.

The insulating member can be a passive heat sinking material that stores heat energy generated during vehicle operation to be returned to the vehicle cavity while the vehicle is parked or at the beginning of vehicle operation, elevating the temperature of the tire for improved efficiency during the “cold” vehicle operation while the tire is stabilizing to its normal (fully warmed-up) operating temperature. The insulating member reduces energy loss from the tire and wheel assembly in the form of heat and should increase the fuel efficiency of the tire for short duration drive cycles where the tire does not typically have time to reach a fully warmed-up operating temperature.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic side view illustration of a vehicle having a first embodiment of a wheel and tire assembly in accordance with one aspect of the present teachings.

FIG. 2 is a schematic cross-sectional illustration of the wheel and tire assembly of FIG. 1 taken at lines 2-2 in FIG. 1.

FIG. 3 is a schematic cross-sectional illustration of a second embodiment of a wheel and tire assembly for the vehicle of FIG. 1 in accordance with another aspect of the present teachings.

### DETAILED DESCRIPTION

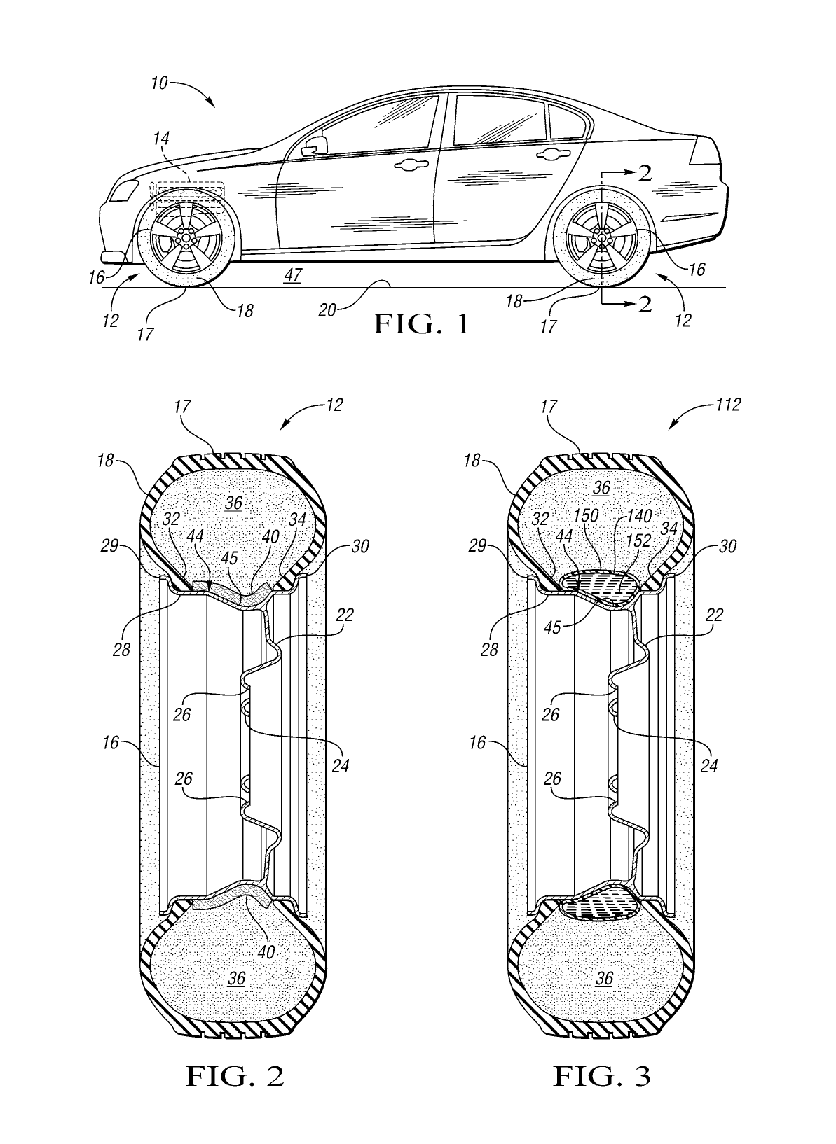

Referring to the drawings, wherein like reference numbers refer to like components throughout the several views, FIG. 1 shows a vehicle 10 that has four tire and wheel assemblies 12 (two shown in FIG. 1). Each tire and wheel assembly 12 is rotatable to move the vehicle 10 when the vehicle 10 is powered by a propulsion system 14. The propulsion system 14 is operatively connected to the wheel assemblies 12, either by a driving connection to the front wheel assemblies 12, the rear wheel assemblies 12, or both. The propulsion system 14 can include an engine, a transmission, and a drive train, in any known combination.

Each tire and wheel assembly 12 includes a wheel 16 and a tire 18 mounted on the wheel 16. The tire 18 is made at least in part of a rubber compound. The entire structure of the tire 18 is constantly changing shape as the tire 18 rotates while the vehicle 10 is moving with respect to the road 20, causing hysteretic losses. Due to the viscoelastic nature of the tire 16, the hysteretic losses of the tire 16 decrease as a temperature of the tire 16 reaches a predetermined tire temperature. For example, as a tread portion 17 of the the tire 16 interfaces with the road 20, shown in FIG. 1, it must flex and deform in accordance with the road surface. The energy consumed to flex and deform in this manner is generally greatest at lower tire temperatures, such as in cold weather, when the vehicle has not been used for a period of time, or when the vehicle is temporarily stopped such as at an extended stop in traffic. Lower tire temperatures are also experienced during periods when the vehicle 10 is driven more slowly. That is, the tire temperature is at least partially dependent on vehicle speed.

Referring to FIG. 2, the wheel 16 has a center disc 22 with a pilot hole 24 and lug nut openings 26 for mounting the wheel to a vehicle axle. The wheel 16 includes an annular rim 28 that can be integrally formed with the disc 22. The rim 28 has seats 29 30 that are configured to receive tire beads 32, 34 of the tire 18. When the tire 18 is inflated via a valve stem (not shown), a pressurized, annular tire cavity 36 is defined by the rim 28 and the tire 18. The tire cavity 36 is enclosed by the rim 28 and the tire 18.

The wheel 16, including the rim 28, is a metallic material such as steel. The wheel 16 has a first thermal conductivity that is greater than a thermal conductivity of the tire 18. For example, if the wheel 16 is an aluminum alloy, it may have a thermal conductivity of about 215 Watts/meter/Kelvin (W/m/K). If the wheel 16 is steel, it may have a thermal conductivity of about 33 W/m/K. Accordingly, in known tire and wheel assemblies, the majority of heat loss from the tire cavity is through the rim of the wheel, leading to longer periods before the temperature of the tire cavity reaches a predetermined operating temperature and greater hysteretic losses. The present tire and wheel assembly 12 solves this problem by providing an insulating member 40 that contacts and covers an entire outer annular surface 42 of the rim 28 between the tire beads 29, 30 that would otherwise be exposed to the tire cavity 36. That is, the insulating member 40 covers an annular surface 44 of the rim 28 between the tire beads 29, 30 at a circumference 45 of the wheel 16 so that the entire cavity 36 is surrounded by the tire 18 and the insulating member 40. In other words, no portion of the wheel 16 is exposed to the tire cavity 36.

The insulating member 40 has a second thermal conductivity lower than the first thermal conductivity of the wheel 16. In other words, the insulating member 40 is a relatively better heat insulator than the wheel 16. For example, the insulating member 40 can be a foam material with a thermal conductivity of 0.03 W/m/K. The material of the insulating member 40 is selected so that the first thermal conductivity will significantly shield heat loss from the cavity 36 at least until the contained air within the cavity 36 reaches a first predetermined temperature corresponding with a desired predetermined operating temperature of the tire 18 and operating efficiency of the tire 18. In one example, the first predetermined operating temperature is about 30 degrees Celsius (° C.) above the ambient temperature in the environment surrounding the tire. If the ambient temperature is 20° C., then the first predetermined operating temperature is 50° C. The rate of heat absorption by the insulating member 40 allows the cavity 36 to reach the first predetermined operating temperature more rapidly than if the surface 44 of the rim 28 was in contact with the cavity 36. The insulating member 40 absorbs heat from the cavity 36 when a temperature of the cavity 36 is above the first predetermined temperature. That is, the rate of heat absorption by the insulating member 40 allows the temperature of the cavity 36 to rise at least to the predetermined operating temperature. The insulating member 40 thus acts as a passive heat sink that stores energy generated during vehicle operation to be returned to the cavity 36 when the vehicle 10 is parked or restarted, elevating the temperature of the tire 18 for improved efficiency during “cold” vehicle operation. Decreasing the heat transfer rate through the wheel 16 may allow the tire 18 to reach a more advantageous temperature level from an energy efficiency point more rapidly, decreasing the energy consumption of the tire 18 and thereby increasing fuel efficiency of the vehicle 10. In other words, the insulating member 40 reduces energy loss from the tire and wheel assembly 12 in the form of heat and increases the fuel efficiency of the tire 18 for short duration drive cycles where the tire 18 does not typically have the time to reach the first predetermined operating temperature.

At least some of the heat absorbed by the insulating member 40 will be released to the ambient surroundings 47 (i.e., outside of the vehicle 10, as indicated in FIG. 1) by heat transfer through the rim 28 when a temperature difference between the insulating member 40 and the ambient surroundings would encourage conductive heat transfer from the insulating member 40 through the tire 18 and/or the wheel 16 to the ambient surroundings 47.

Furthermore, the material of the insulating member 40 is chosen so that when the temperature of the cavity 36 subsequently falls below a second predetermined temperature due to slowing of the vehicle, or a temporary stop of the vehicle, such as during traffic or for a relatively short period on which the vehicle 10 is completely off, a temperature difference between the insulating member 40 and the cavity 36 is such that at least some of the absorbed heat is released from the insulating member 40 into the cavity 36. The second predetermined temperature is lower than the first predetermined temperature. In one example, the second predetermined temperature is lower than the first predetermined temperature by 10° C. So, if the ambient temperature is 20° C., then the second predetermined temperature is 40° C. In other examples, the second predetermined temperature could be any temperature in the range of 5° C. to 20° C. lower than the first predetermined temperature. The release of heat to the cavity 36 aids in raising the tire temperature to at least the predetermined tire temperature more quickly than if the wheel rim 18 was not covered by the insulating member 40.

In the embodiment of FIG. 2, the insulating member 40 is a blanket made of a fibrous material such as, by way of non-limiting example, a non-asbestos heat-absorbing material, a partial ceramic material, or a fiberglass material. The color of the insulating member 40 may be chosen to affect the rate of heat absorption and emissivity by the insulating member 40 to achieve the desired heat shielding and heat release by the insulating member 40. For example, the insulating member 40 can be white or a reflective color in order to reflect a greater portion of a radiative heat back to the cavity 36 and also radiate the absorbed heat to the cavity 36 more slowly. Alternatively, the insulating member 40 can be a dark color, such as black, to radiate the absorbed heat to the cavity 36 more quickly. In either case, the conductive heat transfer of the insulating member 40 is the same. Some heat transfer will also occur from the insulating member to the wheel 18, but because the insulating member 40 has a lower heat conductivity than the wheel 18, the rate of transfer is slowed.

FIG. 3 shows another embodiment of a tire and wheel assembly 112 that can be used on the vehicle 10 in place of the tire and wheel assembly 12. The tire and wheel assembly 112 has many of the same components and features as the tire and wheel assembly 12, as referenced by like reference numbers. The tire and wheel assembly 112 has an insulating member 140 in place of insulating member 40. The insulating member 140 is bladder 150 similar to an inner tube. The bladder 150 can be a rubber or other polymer material. The bladder 50 is filled with a substance 152 that has a heat capacity that is greater than the heat capacity of the air in the tire cavity 36. The substance 152 can be a liquid or a gel. Like the insulating member 40, the insulating member 140 will shield heat loss from the tire cavity 36 by completely covering the surface 44 of the wheel rim 28. The insulating member 140 has a thermal conductivity that allows the cavity 36 to heat to at least a predetermined desired operating temperature associated with a desired temperature of the tire 18. When the cavity 36 falls to a second predetermined temperature less than the first predetermined temperature, either due to slowing of the vehicle 10 or temporary stopping of the vehicle 10, the subsequent temperature differential will cause the absorbed heat to be released by at a rate that will warm the temperature of the cavity 36 back to the predetermined operating temperature. That is, the rate of heat absorption by the insulating member 140 allows the temperature of the cavity 36 to rise at least to the predetermined operating temperature. The insulating member 140 thus acts as a passive heat sink that stores energy generated during vehicle operation to be returned to the cavity 36 when the vehicle 10 is parked or restarted, elevating the temperature of the tire 18 for improved efficiency during “cold” vehicle operation.

In one embodiment, the bladder 150 is a tubular polymer material that has a thermal conductivity lower than that of the wheel 16. The liquid or gel substance 152 has a relatively high heat capacity that is greater than the heat capacity of air. That is, the substance 152 has a second heat capacity greater than a first heat capacity of air. If the substance 152 is a liquid, it can be a silicon-based material, or any other material that can either remain a liquid or at least partially solidify as it absorbs heat. As the substance 152 releases heat, it returns to liquid form. If the substance 152 is a gel, it can be a similar material as the liquid, in gel form, and can include a phase-change agent that allows the substance 152 to improve the heat absorption or rejection of the blanket 150. Known phase-change agents cause the material to change from a gel to a liquid or from a gel to a solid over a predetermined temperature range. In changing phase from a gel to a liquid or from a solid to a liquid, such materials absorb and store latent heat, and in changing phase from a liquid to a gel or a solid, such materials release heat. Despite the phase change, however, the material with the phase change agent maintains a relatively constant temperature.

While the best modes for carrying out the many aspects of the present teachings have been described in detail, those familiar with the art to which these teachings relate will recognize various alternative aspects for practicing the present teachings that are within the scope of the appended claims.

1. An assembly comprising:
a wheel having a rim; wherein the wheel has a first thermal conductivity;
a tire attached to the wheel to define an annular tire cavity enclosed by the tire and the rim;
an insulating member on the rim within the tire cavity; and wherein the insulating member has a second thermal conductivity lower than the first thermal conductivity and is configured to absorb heat from the cavity when a temperature of the cavity is above a first predetermined temperature and release the absorbed heat back to the cavity when the temperature of the cavity is below a second predetermined temperature lower than the first predetermined temperature.

2. The assembly of claim 1, wherein the rim has an outer annular surface facing the tire cavity; wherein the insulating member substantially surrounds the outer annular surface.

3. The assembly of claim 1, wherein the insulating member is a fibrous material.

4. The assembly of claim 3, wherein the fibrous material is white to reflect at least some heat back into the tire cavity.

5. The assembly of claim 3, wherein the fibrous material is black.

6. The assembly of claim 1, wherein the insulating member is a bladder.

7. The assembly of claim 6, wherein air in the tire cavity has a first heat capacity; and wherein the bladder is filled with a substance having a second heat capacity greater than the first heat capacity.

8. The assembly of claim 7, wherein the substance is a liquid.

9. The assembly of claim 7, wherein the substance is a gel.

10. The assembly of claim 1, wherein the tire has tire beads supported on the rim; wherein the rim has a surface extending between the tire beads and facing the tire cavity; and wherein the insulating member completely covers the surface of the rim facing the tire cavity.

11. An assembly comprising:
a wheel having a rim; wherein the wheel has a first thermal conductivity;
a tire attached to the wheel to define an annular tire cavity enclosed by the tire and the rim; wherein the tire has a predetermined operating efficiency at a predetermined tire temperature;
a bladder on the rim within the tire cavity; wherein the bladder extends around a circumference of the wheel and is filled with gel that has a second thermal conductivity lower than the first thermal conductivity; and
wherein the gel is configured to absorb heat from the cavity when a temperature of the cavity is above a first predetermined cavity temperature and release the absorbed heat back into the cavity when the temperature of the cavity is below a second predetermined cavity temperature lower than the first predetermined cavity temperature thereby aiding in maintaining the predetermined tire temperature to achieve the predetermined operating efficiency.

12. The assembly of claim 11, wherein the rim has a surface facing the tire cavity; and wherein the insulating member completely covers the surface of the rim facing the tire cavity.

13. The assembly of claim 11, wherein the rim has an outer annular surface facing the tire cavity; wherein the insulating member substantially surrounds the outer annular surface.

14. A vehicle comprising:
a propulsion system;
a wheel having a rim; wherein the wheel has a first thermal conductivity;
a tire attached to the wheel to define an annular tire cavity enclosed by the tire and the rim;
a propulsion system operatively connected to the wheel; wherein the wheel rotates to move the vehicle when propelled by the propulsion system; wherein hysteretic losses of the rotating tire decrease as a temperature of the tire reaches a predetermined tire temperature;
an insulating member on the rim within the tire cavity; and wherein the insulating member has a second thermal conductivity lower than the first thermal conductivity and is configured to absorb heat from the cavity when a temperature of the cavity is above a first predetermined temperature and release the absorbed heat back into the cavity when the temperature of the cavity is below a second predetermined temperature lower than the first predetermined temperature thereby aiding in raising the tire temperature to at least the predetermined tire temperature.

15. The vehicle of claim 14, wherein the rim has an outer annular surface facing the tire cavity; and wherein the insulating member substantially surrounds the outer annular surface.

16. The vehicle of claim 15, wherein the insulating member is a fibrous material.

17. The vehicle of claim 15, wherein the insulating member is a bladder.

18. The vehicle of claim 15, wherein air in the tire cavity has a first heat capacity; and wherein the bladder is filled with a substance having a second heat capacity greater than the first heat capacity.

19. The vehicle of claim 18, wherein the substance is a liquid.

20. The vehicle of claim 18, wherein the substance is a gel.
